(19) United States
(12) Patent Application Publication
(10) Pub. No.: US 2025/0235885 A1
(43) Pub. Date: Jul. 24, 2025

(54) INTEGRATED ROTARY SPRAYER

(71) Applicant: Kohler (China) Investment Co., Ltd., Jing’an District (CN)

(72) Inventors: Mauricio CARVAJAL, Shanghai (CN); Dong YAN, Shanghai (CN)

(21) Appl. No.: 19/016,636

(22) Filed: Jan. 10, 2025

(30) Foreign Application Priority Data
Jan. 19, 2024 (CN) 202410082746.5

(51) Int. Cl. B05B 3/04; B05B 7/00; E03C 1/04

(52) U.S. Cl. CPC B05B 3/0422; B05B 7/005; E03C 1/0405

(57) ABSTRACT

A faucet assembly that includes a faucet body and a rotary sprayer with spray jet nozzles. The rotary sprayer with spray jet nozzles rotates about an axis itself, and/or the nozzles are individually configured to rotate about an axis to provide high-pressure liquid along an interior or exterior of an object, including otherwise difficult to reach areas. The rotary sprayer may be integrated into the faucet body, positioned on an external surface of the faucet body, or positioned remotely from the faucet body. The rotary sprayer may include any combination of optional features such as, but not limited to, attachable cleaning tools or modules, dispensing of cleaning agents or additives, generating microbubbles, nanobubbles, ozonated, and/or electrolyzed liquid, generating steam, generating UV light or ultrasonic waves, drying capabilities, and the like.

### RELATED APPLICATIONS

This application claims priority to Chinese Utility Model patent application No. 202410082746.5, entitled “Integrated Rotary Sprayer” and filed on Jan. 19, 2024, the entirety of which is hereby incorporated by reference.

### TECHNICAL FIELD

Examples herein generally relate to faucet assemblies for dispensing liquids or fluids. More specifically, the present disclosure describes a rotary sprayer that, by itself or as part of a faucet assembly, disperses liquid or fluid to clean an object.

### BACKGROUND

Traditionally, a faucet encompasses a singular pathway or channel for liquid or fluid to pass (herein referred to as “liquid” for sake of efficiency). In operation, the liquid is dispersed out of an outlet of the faucet and by itself, or in combination with cleaning solutions, is used to remove remnants, residue, or other particulates off dishes, containers, or other objects. However, because the liquid is only dispersed along a singular pathway at a particular pressure, the liquid often does not adequately clean or remove particulates from an object. This is often the case when dishes or objects include troublesome or hard to reach internal or external corners. While external tools may be used in the form of sponges, brushes, or other handheld devices to assist in the cleaning, such tools often run the risk of breaking or damaging delicate and fragile objects. Moreover, if not cleaned properly themselves, the tools may subject an object to undesirable smells and bacteria. After cleaning, such objects must be dried. Drying can be achieved through either manual or air drying. Manual drying often requires a user to manually dry the object using towels or rags that prove troublesome if the user is in a hurry or suffers from physical ailments impeding their ability to dry the object. Further, such towels may often be overutilized and, in turn, contain bacteria that may be displaced on the object. Alternatively, air drying often results in streaks/stains and necessitates a long waiting time.

What is needed in the field is a spraying assembly that allows for efficient and optimal cleaning of an object without requiring significant user effort. There is a further need for a faucet assembly with additional cleaning technologies that may assist in the cleaning and/or drying process.

### SUMMARY

Examples according to the disclosure are generally directed to a faucet assembly that includes a faucet body and a rotary sprayer with spray jet nozzles. The rotary sprayer with spray jet nozzles is configured to rotate about an axis itself, and/or the nozzles are individually configured to rotate about an axis to provide high-pressure liquid along an interior or exterior of an object, including otherwise difficult to reach areas. The rotary sprayer may be integrated into the faucet body, positioned on an external surface of the faucet body, or positioned remotely from the faucet body. The rotary sprayer may be configured to include any combination of optional features such as, but not limited to, attachable cleaning tools or modules, dispensing of cleaning agents or additives, generating microbubbles, nanobubbles, ozonated, and/or electrolyzed liquid, generating steam, generating UV light or ultrasonic waves, drying capabilities, and the like.

An example according to the disclosure relates to a faucet assembly that includes a faucet and an integrated, retractable rotary sprayer with spray jet nozzles integrated within the body of the faucet. The faucet includes an actuating mechanism to release and/or activate the rotary sprayer. Once active, the rotary sprayer displaces water or other liquid in a high-pressure fashion along the interior or exterior of an object to be rinsed, cleaned, and/or sanitized. Further, when active, the rotary sprayer is driven through either water pressure or an electrical power source to rotate along a circular axis. This ensures troublesome areas along an object are reached in an efficient and optimal manner. The rotary sprayer may be turned off or deactivated by a user engaging the same actuating mechanism and returned to the body of the faucet. The rotary sprayer herein is compatible with numerous faucet designs, e.g., an arc spout faucet, a flat spout faucet, etc.

In another example, the rotary sprayer may be situated on an external surface of a spray head body. For example, a rotary sprayer may include multidirectional nozzles that allow for cross-action water dispersion along an interior or exterior of an object. In this example, a user can switch operating modes between a traditional operating mode, engaging an outlet of the faucet, and a nozzle mode, employing the rotary sprayer, using a diverter of the faucet assembly. Alternatively, in another example, the externally positioned nozzles of the rotary sprayer may be actuated through a sliding cover that is configured to slide along the body of the faucet to expose and actuate the nozzles. Once exposed, the nozzles rotate along a circular axis and provide high pressure water. To disengage the nozzles, the user may return the sliding cover to its default position over the nozzles to cease operation of the rotary sprayer.

While a rotary sprayer may be located internal or external to a spray head body, in other examples, a spray head may also include additional sprayers in addition to the rotary sprayer. For example, a spray head body may include an aerated sprayer for normal filling or washing needs; a specialized sprayer(s) in the form of a full, sweep, or mist or fine mist sprayer, such as a BerrySoft™ spray pattern, to help clean an exterior of a container; and a rotary sprayer to easily clean deep containers. It is contemplated that additional or fewer sprayers may be included as part of this faucet assembly as well. However, in this example, it is to be understood that a spray head may include any number of sprayers in addition to the rotary sprayer.

Additionally, in some examples, the rotary sprayer may also be configured to attach to cleaning modules. Such modules may take the form of brushes, bristles, etc. Once coupled, the modules leave the nozzles exposed so a user can simultaneously use the modules and the integrated rotary sprayer. This example is especially useful for objects with deep grooves and troublesome residue. The modules may comprise a wide variety of materials such as silicone, plastic, etc. Alternatively, such modules may be integrated along with the rotary sprayer and rotate along with the sprayer. In this example, a user may simultaneously engage both the rotary sprayer and modules through deployment of the rotary sprayer from a spray head body. Once deployed, a user may return the rotary sprayer and modules into the housing through actuation of an actuating mechanism. As it returns into the spray head, water and dirt may be squeezed out of the modules so that the module is cleaned as it reintegrates into the spray head. Such integrated modules may include scrubbers with ridged surfaces that consist of silicone, thermoplastic polyurethane, etc.

To further aid in a cleaning operation, a rotary sprayer may also perform additional functions beyond spraying liquid. For example, a rotary sprayer may be equipped with microbubble or nanobubble functionality that disperses microbubbles or nanobubbles into a liquid. In this example, a user may use an actuating mechanism of the faucet assembly to engage the microbubble or nanobubble function of the rotary sprayer. Once active, the rotary sprayer delivers microbubbles or nanobubbles capable of getting into small crevices and removing debris such as dirt and oil, killing bacteria, and breaking down pesticides. This function reduces the need for scrubbing and large quantities of cleaning agent such as detergent. Other optional functions of the rotary sprayer may include the ability to produce electrolyzed water and/or ozonated water. In another example, a rotary sprayer may be able to dispense a liquid containing multiple components. Specifically, a faucet assembly may include a dispensing function capable of receiving a descaling solution, soap capsule, or other cleaning solution to aid in the cleaning process. Once activated, a dispensing function of the faucet assembly can dispense soap, detergent, bleach, scaling solutions, or any other compounds into a fluid stream to be dispersed by the rotary sprayer. This infusion allows for a more streamlined approach in some examples.

Up to this point, while a rotary sprayer has been discussed as integrated, or affixed to, a spray head of the faucet body, in other examples, the rotary sprayer may be a separate add-on component, a side sprayer, or a standalone component. Specifically, in one example, as a separate add-on component, a rotary sprayer may be independent from a faucet, and, in operation, can attach to an appropriately sized receiver portion of a spray head body. Different receiving portions and heads may be manufactured depending on faucet SKUs. Alternatively, as a side sprayer, the rotary sprayer may operate along with an aerated nozzle for spraying a liquid. In this example, the side sprayer may include rotary nozzles along an outer circumference of the faucet that possess the power jet rotary feature. Specifically, the interior of the outlet may include a more traditional aerated nozzle while the exterior contains rotary nozzles. A pull-out hose may also connect to the side sprayer to allow for improved flexibility and control. As a standalone product, the rotary sprayer can operate independently of a faucet and may couple to a water input located in a kitchen or an external water reservoir. Here, the rotary sprayer is an independent spraying system altogether.

Finally, a faucet assembly may include additional functionality that assists a user in carrying out a cleaning operation using a rotary sprayer. For example, a faucet assembly may include the ability to emit light that can highlight the clarity of a vessel before or after a wash cycle with a rotary sprayer. In one example, the light may be ultraviolet light or any other wavelength capable of highlighting residue before or after a cleaning cycle. The light may be emitted upon activation of an actuating mechanism on the faucet assembly. In another example, a faucet assembly may include the ability to emit ultrasound waves to help release dirt and other residue prior to, or during use of, a rotary sprayer. In this example, a user may rinse or clean an object using the high-pressure nozzles of the rotary sprayer. While the object remains full of liquid, a user may activate the ultrasound function to emit ultrasound waves to soften or dislodge stuck residue from the object. Subsequently, the rotary spraying function may be re-activated to finish cleaning the object. In other examples, a faucet assembly may include a drying feature that emits rapid, warm air to dry washed objects faster. Here, a rotary sprayer may be used to wash an object and then the drying feature of the faucet assembly engaged to dry the object quickly without leaving mold, stains, or streaks. Finally, a faucet assembly with a rotary sprayer may also include the ability to deliver steam to soften any remaining residue and achieve deep sterilization of an object. Such components may be integrated into a rotary sprayer itself or a faucet.

It is to be understood that the above general description is exemplary and explanatory only and is not restrictive of the system as claimed. The system can be capable of other examples and of being carried out in various ways. Alternative exemplary examples can relate to other features and combination of features.

### BRIEF DESCRIPTION OF THE DRAWINGS

FIG. 1A is a perspective view of a faucet assembly with a rotary sprayer in a storage position in accordance with an example of the present invention.

FIG. 1B is a perspective view of an actuated or extended rotary sprayer in accordance with an example of the present invention.

FIG. 1C are different faucet types that may be used with a rotary sprayer in accordance with examples of the present invention.

FIG. 2A is a perspective view of a rotary sprayer located on an external surface of a spray head body in accordance with an example of the present invention.

FIG. 2B is an illustrative spray pattern of a rotary sprayer in accordance with an example of the present invention.

FIG. 2C is another example of an operative rotary sprayer located on an external surface of a spray head body in accordance with an example of the present invention.

FIG. 2D is an example of an inoperative rotary sprayer located on an external surface of a spray head body in accordance with an example of the present invention.

FIG. 3 is a perspective view of a faucet assembly with multiple sprayers in accordance with an example of the present invention.

FIG. 4A is a perspective view of a rotary sprayer configured to couple to cleaning modules in accordance with an example of the present invention.

FIG. 4B are cleaning modules that may be used with a rotary sprayer in accordance with examples of the present invention.

FIG. 4C illustratively shows a rotary sprayer with an integrated cleaning module in accordance with an example of the present invention.

FIG. 5A is a perspective view of a rotary sprayer with microbubble functionality in accordance with an example of the present invention.

FIG. 5B is a perspective view of a faucet assembly with a rotary sprayer and a dispenser in accordance with an example of the present invention.

FIG. 6A illustratively shows an add-on rotary sprayer according to one example of the present invention.

FIG. 6B is a perspective view of a side sprayer with a rotary sprayer in accordance with an example of the present invention.

FIG. 6C is a perspective view of a standalone rotary sprayer in accordance with an example of the present invention.

FIG. 7 is a perspective view of a faucet assembly with a rotary sprayer and light emitting device in accordance with an example of the present invention.

FIG. 8 is a perspective view of a faucet assembly with a rotary sprayer and ultrasound device in accordance with an example of the present invention.

FIG. 9 is a perspective view of a faucet assembly with a rotary sprayer and a dryer in accordance with an example of the present invention.

FIG. 10 is a perspective view of a faucet assembly with a rotary sprayer and a steam wand in accordance with an example of the present invention.

While various examples are amenable to various modifications and alternative forms, specifics thereof, have been shown by way of example in the drawings and will be described in detail. It should be understood, however, that the intention is not to limit the claimed disclosures to the particular examples described. On the contrary, the intention is to cover all modifications, equivalents, and alternatives falling within the spirit and scope of the subject matter as defined by the claims.

### DETAILED DESCRIPTION

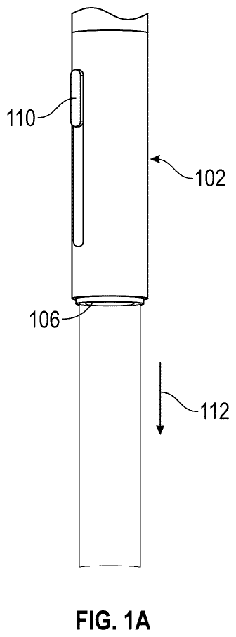

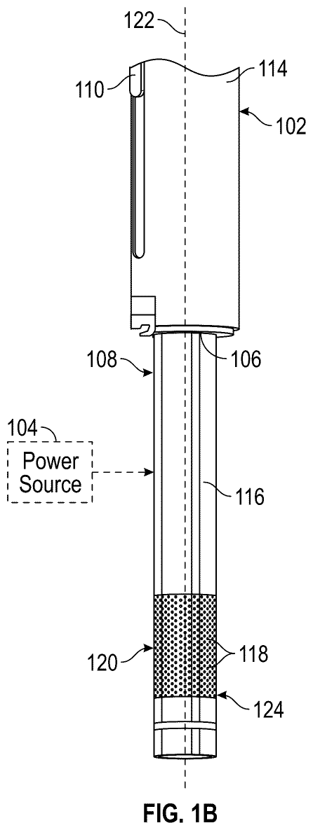

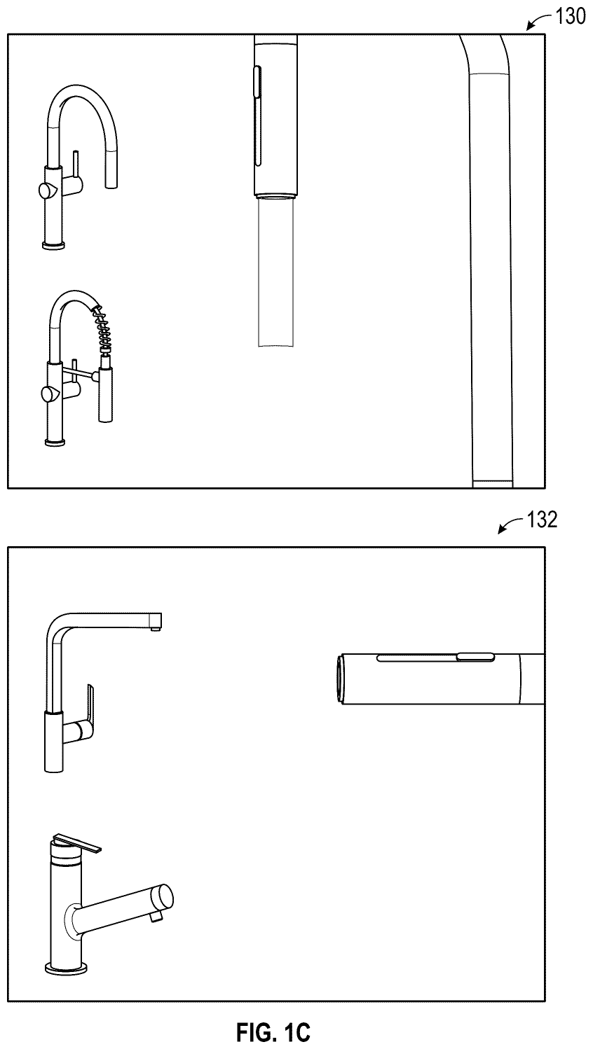

FIG. 1A shows a faucet assembly with a retractable rotary sprayer in a storage position within a spray head of a faucet. Faucet assembly 100 includes a spray head 102 and an actuating mechanism 110 for deploying a retractable rotary sprayer (not shown). Actuating mechanism 110 may include a button, slider, touchless sensor, handle positioning device, etc. Spray head 102 includes an outlet 106 for dispersing both liquid and the rotary sprayer housed within spray head 102. Rotary sprayer 108 can be coupled to and stored within an interior channel of spray head 102 through a coupling mechanism (not shown), which, in one example, includes a fastening mechanism, weld, etc.

In operation, while a rotary sprayer is in a storage position within spray head 102, faucet 114 remains operative and may dispense liquid through an aerated nozzle along path 112. Upon engaging actuating mechanism 110, a stored rotary sprayer may be deployed out of outlet 106. Liquid may then be dispensed out of a rotary sprayer to clean an object as will be discussed below with respect to FIG. 1B. Once deployed, rotary sprayer 108 may be returned to the storage position within the housing of spray head 102 through re-engagement of actuating mechanism 110.

FIG. 1B illustratively shows a rotary sprayer in an operative position. Rotary sprayer 108 includes a rotary body 116, a spraying portion 120 with one or more nozzles 118 in the form of water pressure jets, and a rotary mechanism 124. While nozzles 118 are in the form of water pressure jets 118, other types of nozzles may be used as well. Further, nozzles 118 may include any number of nozzles. Rotary body 108 may be made of any suitable metals or materials and vary in length. For example, a particular length may be desirable depending on a housing size of spray head 102 and/or depth of objects to be cleaned. As such, a variety of lengths and materials are contemplated herein. Such materials may include stainless steel, aluminum, copper, zinc, ABS, nylon, etc.

In operation, rotary sprayer 108 rotates and dispenses liquid in a high-pressure fashion along an interior or exterior of an object. Specifically, rotary mechanism 124 allows spraying portion 120 to rotate along an axis 122 while nozzles 118 dispense high-pressure liquid. Rotary mechanism 124 may operate through either water flow pressure or power source 104. Power source 104 can include a motor or any other components capable of inducing rotational movement to spraying portion 120. Additionally, power source 104 may be internal or external to faucet assembly 100. From this rotational movement and high-pressure spray, a user may effectively and efficiently clean every corner of an object, e.g., glasses, jugs, bottles, etc. Moreover, this allows for easy and quick cleaning inside and outside of every object. In other examples, if enhanced water is used, rotary sprayer 108 may reduce the amount of detergent needed to adequately clean an object.

FIG. 1C are faucet examples in which a rotary sprayer may be used. In one example, rotary sprayer 108 may be implemented in an arc spout faucet assembly 130 with pull down/swing/semi pro functionality and work in parallel with an aerator sprayer of faucet 130. In other examples, rotary sprayer 108 may be implemented in flat spout faucets 132 with pull out and swing functionality. In one example, rotary sprayer 108 may work independently from an aerator sprayer within faucet 132. While two faucet designs are shown, additional or alternative faucet designs may be used in accordance with the present invention as well.

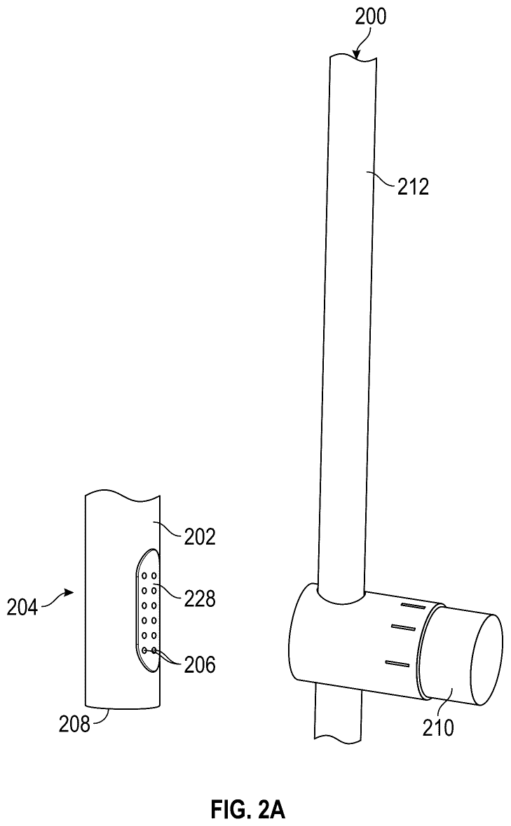

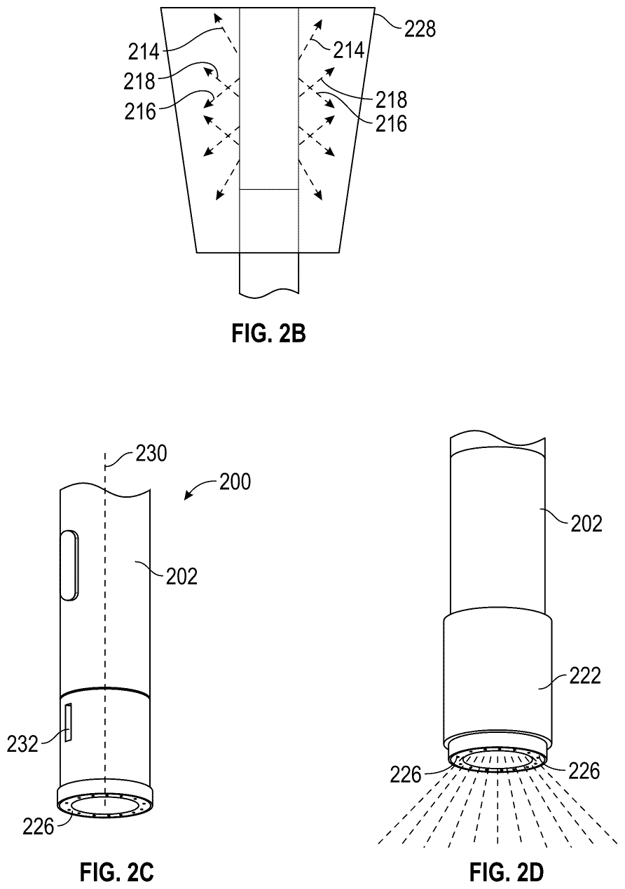

FIG. 2A is a perspective view of a rotary sprayer on an external surface of a spray head body. As shown, rather than being integrated into a spray head body, rotary sprayer may be positioned on an external surface of a spray head body. In one example, rotary sprayer 204 may include multi-directional nozzles that operate to dispense a fluid in a cross-action fashion, as described in FIG. 2B, to effectively clean an object without necessitating rotational movement. Nozzles 206, in one example, may include spray jet nozzles fixed to a pad 228 on each side of spray head body 202. As noted above, nozzles 206 may take a variety of forms in the present invention. Pad 228 may include any number of designs and materials to couple nozzles 206 to rotary sprayer 204. In one example, pad 228 includes a flexible, rubber design that fits within a groove of spray head body 202. In other examples, pad 228 may be manufactured as part of spray head 202 and be made of various metals. Further, while two rotary sprayers 204 are affixed to each side of spray head body 202, in other examples, one or more rotary sprayers 204 may be attached or functionally integrated into spray head body 202.

In operation, a user may use a diverter 210 of faucet assembly 200 to alternate between different operating modes of faucet assembly 200. In a first operating mode, liquid from a liquid source (not shown) is dispersed via nozzles 206 of rotary sprayer 204. In a second operating mode, water or liquid is dispersed through an outlet 208 of spray head body 202 while nozzles 206 remain inoperative. In this example, outlet 208 may include a separate, aerated nozzle (not shown) that dispenses liquid out of spray head body 202. Depending on the desired output of a liquid and cleaning task, a user may selectively choose either operating mode. Additionally, it is expressly contemplated that fewer or additional operating modes may be implemented as well. For example, it may be desirable to have faucet assembly 200 operate in a singular mode. However, additional operating modes may be implemented as well.

FIG. 2B is an example spray pattern of a rotary sprayer, e.g., rotary sprayer 204. As shown, the outermost nozzles 206 of rotary sprayer 204 may be configured to disperse liquid in a high-pressure manner along angles 214. In one example, angles 214 include roughly 45-degree angles. However, other angles are also expressly contemplated herein. Further, in this example, the nozzles 206 positioned between the outermost nozzles may be configured to disperse liquid in a cross-action fashion along paths 216 and 218. In this arrangement, nozzles 206 may efficiently and effectively clean an object 228 of interest. While object 228 is shown as a cup, a wide variety of other objects 228 may be cleaned as well. For example, object 228 may include containers, dishes, cups, or any other objects to be cleaned.

FIGS. 2C and 2D illustrate additional examples of a rotary sprayer on an external surface of a spray head body. In these examples, a rotary sprayer may include nozzles 232 that fully encapsulate an external portion of spray head 202 . . . . In operation, nozzles 232 may be engaged through different actuating mechanisms and, once active, rotate along an axis 230 to disperse high pressure liquid to clean an object. For example, in FIG. 2C, nozzles 232 may be activated through a diverter or handle to engage nozzles 232. Alternatively, as shown in FIG. 2D, a slidable cover, or sleeve, 222 may be displaced to expose and automatically activate nozzles 232. Upon being exposed, nozzles 232 may operate to disperse liquid and rotate in a circular manner. In turn, to render nozzles 232 inoperative, cover 222 may be positioned back over nozzles 232. This may serve as a default position in some examples. Specifically, as shown in FIG. 2D, when cover 222 is placed over nozzles 232, nozzles 232 may be rendered inoperative and, in turn, liquid dispensed out of nozzle 226, which, in one example, may be an aerated nozzle. However, other nozzle types may be used as well. Moreover, while cover 222 is shown physically coupled to spray head body 202, in other examples, cover 222 may be a separate piece capable of being detached from spray head body 220 altogether. In this example, cover 222 may be removably attached or detached to operate rotary sprayer 204.

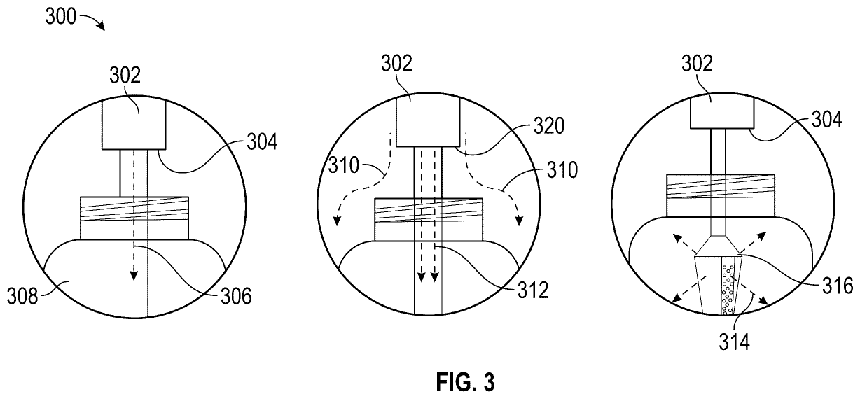

In some examples, a spray head may include additional sprayers along with, or in addition to, a rotary sprayer. For example, FIG. 3 is a perspective view of a faucet assembly with a rotary sprayer and additional sprayers. In one example, a faucet assembly 300 includes a spray head body 302 with three different types of sprayers. Here, faucet assembly 300 includes a rotary sprayer 316, aerated sprayer 304, and one or more specialized sprayers 320 all within spray head 302. In operation, sprayer 304 allows for an aerated stream along a path 306 and into an interior of object 308. Specialized sprayers 320 may include a Full, Sweep, Berrysoft or mist, etc. sprayers to help clean an exterior 310 of object 308. Through specialized sprayer 320, a user can simultaneously clean an exterior 310 and interior 312 of object 308. Rotary sprayer 316 may be housed within spray head body 302 and deployed to dispense liquid in a circular manner 314 along an interior of object 308. Rotary sprayer 316 serves especially useful if object 308 is a deep container, glassware, jug, or bottle. Depending on a user's needs, a user may cycle through each spray type using a diverter, actuating mechanism in the form of a button, switch, sensor, etc., or any other form of mechanism that allows for engagement of the different nozzle types. Alternatively, in some instances, nozzles 316, 304, and 320 may all be active at the same time. While three types of sprayers are discussed, it is contemplated that additional or different types of sprayers may be used as well in accordance with examples of the present invention.

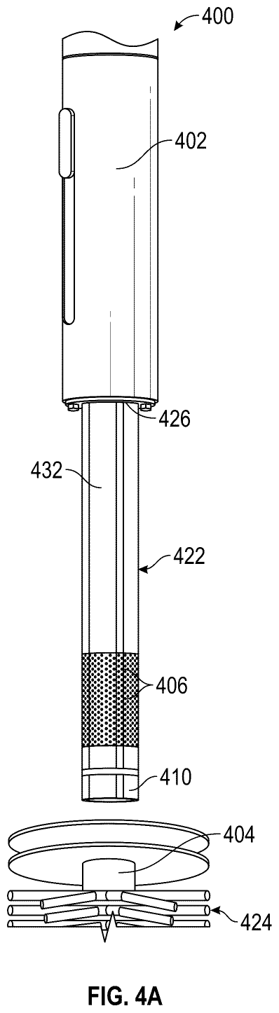

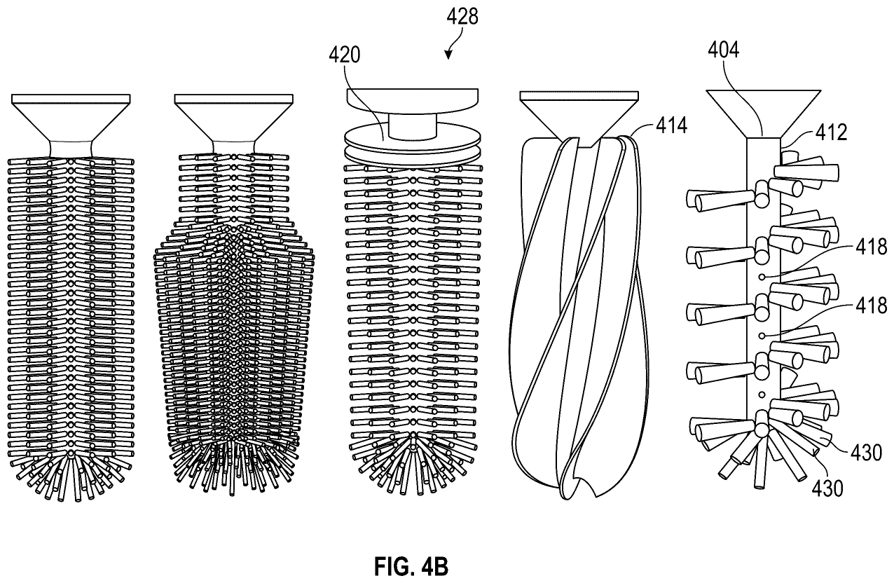

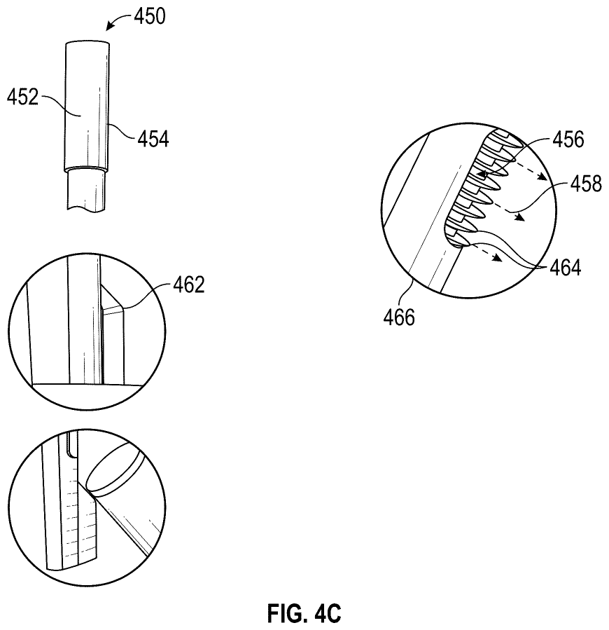

In some examples, a rotary sprayer may also couple to cleaning modules to assist a user in carrying out a cleaning operation. For example, FIG. 4A is a perspective view of a rotary sprayer capable of coupling to a cleaning module in accordance with an example of the present invention. As shown, faucet assembly 400 includes a rotary sprayer 422 coupled to a spray head body 402. Rotary sprayer 422 includes a tip 410 and a body 432 configured to be received by an inlet 404 of a cleaning module 424. In operation, tip 410 can be pressed into receiving inlet 404 so that cleaning module 424 can encompass body 432 of rotary sprayer 422 and secure cleaning module 424 to rotary sprayer 422. In other examples, rotary sprayer 422 and/or cleaning module 424 may include a locking mechanism, e.g. a protrusion, latch, etc., to securely fasten cleaning module 424 to rotary sprayer 422.

Once cleaning module 424 is attached to rotary sprayer 422, a user can employ cleaning module 424 in the cleaning process. For example, cleaning module 424 may include holes or openings (not shown) matching nozzles 406 to allow liquid to be dispensed through cleaning module 424. In turn, a user may use cleaning module 424 to scrub troublesome residue or particulates while rotary sprayer 422 simultaneously sprays liquid.

FIG. 4B depicts several types of cleaning modules that may be used with a rotary sprayer. As illustratively shown, cleaning modules 428 can assume a wide variety of configurations. For example, cleaning modules 428 may have silicone brushes, plastic bristles, natural material bristles, etc. In one example, cleaning module 428 includes a body 412 with holes 418 and projectiles 430. Projectiles 430 may take a wide variety of different forms, e.g., bristles, brushes, etc., and take on different arrangements. Each arrangement may be suitable for a particular cleaning application so that a user can selectively couple a particular cleaning module 428 based on the desired task. For example, if an object includes a lot of grooves, a cleaning module with a lot of projectiles 430 may be needed. Alternatively, if an object consists of relatively few or no grooves, cleaning module 428 may have few or no projectiles 430. Additionally, in other examples, cleaning modules 428 may include collars 420 or ridges 414 that extend from a body 412 of cleaning module 428. While five examples are illustratively shown, it is expressly contemplated that additional cleaning modules 428 may be used as well.

Alternatively, a cleaning module may also be located on an external surface of a spray head body with a rotary sprayer. For example, FIG. 4C illustratively shows a faucet assembly 450 with a cleaning module 454 located on an external surface of a spray head 452. In some examples, cleaning module 454 may take the form of a squeegee 454, that can be used to scrape off residue. In other examples, rather than coupling to spray head body 452, squeegee 454 may couple directly to a rotary sprayer (not shown). In this example, squeegee 454 may be extended and retracted simultaneously with rotary sprayer 422. In operation, as the rotary sprayer is retracted into spray head 452, water and dirt may be squeezed out of squeegee 454 to clean squeegee after each use. Additionally, while operative, squeegee 454 may rotate along with the nozzles of the rotary sprayer to clean object 462.

It is also contemplated that other types of cleaning modules, other than squeegee 454, may be used as well. In one example, cleaning module may include an integrated brush 456, or scrub, with ridged surfaces 464 that may be used to clean crevices and exteriors of an object. Surfaces 464 may be made of silicone, TPU, bristles, etc. Additionally, brush 456 may take a variety of shapes and configurations. In one example, brush 456 may surround nozzles (not pictured) on spray head body 466 to allow a liquid to be dispersed from an interior of brush 456, as shown by numeral 458. A user may then simultaneously use brush 456 while nozzles are actively dispensing a liquid.

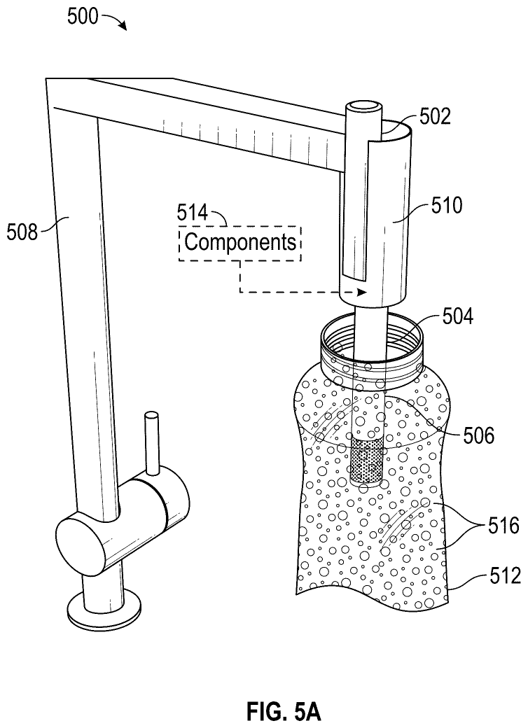

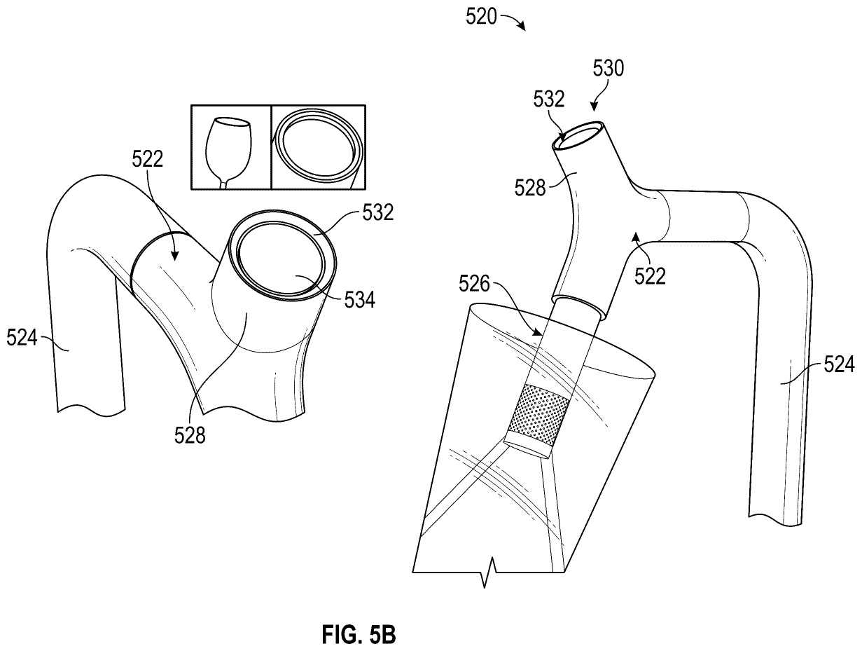

To further assist a user in a cleaning operation, a rotary sprayer may include additional functionality beyond spraying a liquid. For example, FIG. 5A is a perspective view of a rotary sprayer capable of dispensing microbubbles, nanobubbles, or any other bubbles in accordance with an example of the present invention. Faucet assembly 500 includes a faucet 508 with a spray head 510 coupled to a rotary sprayer 504. Rotary sprayer 504 includes nozzles 506 that can dispense bubbles 516 into a liquid within an object 512. While bubbles 516 are illustratively shown as microbubbles 516, it is contemplated that, in other examples, bubbles may include nanobubbles or any other sizes bubbles. Microbubble functionality can be provided through components 514 which, in one example, include a motor, heater, and tubing configured to supply hot air through nozzles 506 of rotary sprayer 504 to produce microbubbles 516. However, additional, or alternative components 514 may be used as well. For example, components may include an aerator or electrical generator configured to inject air into a liquid. In operation, components 514 may be activated through an actuating mechanism 502. Actuating mechanism 502 may consist of a button, switch, sensor, or any other mechanism capable of activating components 514 and the microbubble functionality of rotary sprayer 504. In operation, microbubbles 516 may reduce the need for scrubbing and detergent altogether. For example, microbubbles 516 consist of tiny bubbles that can get into small crevices, act as a scrubbing element, remove oil and residue, kill bacteria, and break down pesticides.

In other examples, a rotary sprayer may spray a liquid solution containing various types of liquids, gases, or solids. For example, FIG. 5B is a perspective view of a faucet assembly with a dispenser that may be used to receive a solution to be sprayed through a rotary sprayer. In this example, faucet assembly 520 may include a faucet 524, a spray head body 522 coupled to a dispenser 530 and a rotary sprayer 526. Dispenser 530 illustratively includes an extended housing 528 and an inlet 532 for receiving a capsule or liquid solution 534. Liquid solution 534 may include detergent, soap, descaling solution, or any other liquid. Once placed into inlet 532, liquid 534 is infused into water or other liquid within spray head body 522 and transferred to rotary sprayer 526 to be dispersed. Through dispenser 530, cleaning of an object may be more streamlined as rotary sprayer 526 disperses the mixed solution.

In another example, inlet 532 may be appropriately sized to receive and/or pierce a capsule or pod containing a liquid solution. In this example, rather than directly inserting liquid into dispenser 530, a pod housing the liquid may be placed within inlet 532. Once positioned within inlet 532, a piercing, pinching, etc. component (not shown) may then automatically, or upon manual activation, engage the pod to release the liquid. In some examples, manual activation may be supplied through an actuation mechanism in the form of a button, switch, lever, etc. to trigger the component. Component may include a blade, pointed tip, or any other mechanism capable of engaging the pod to release the liquid. Once released, the pod may then be discarded or reused in some examples.

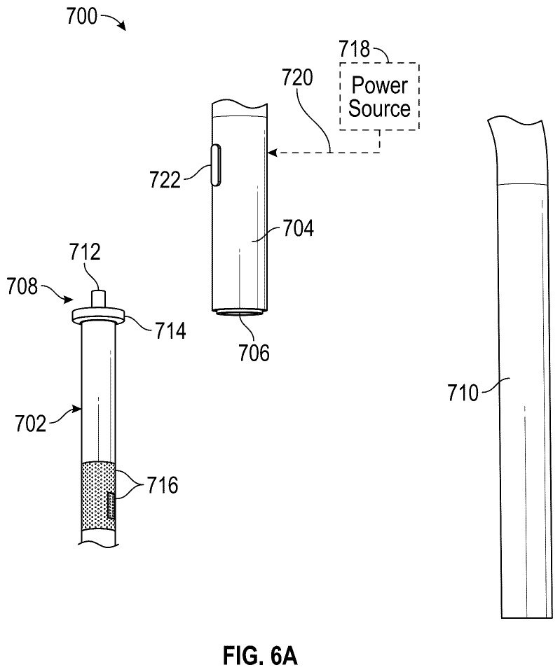

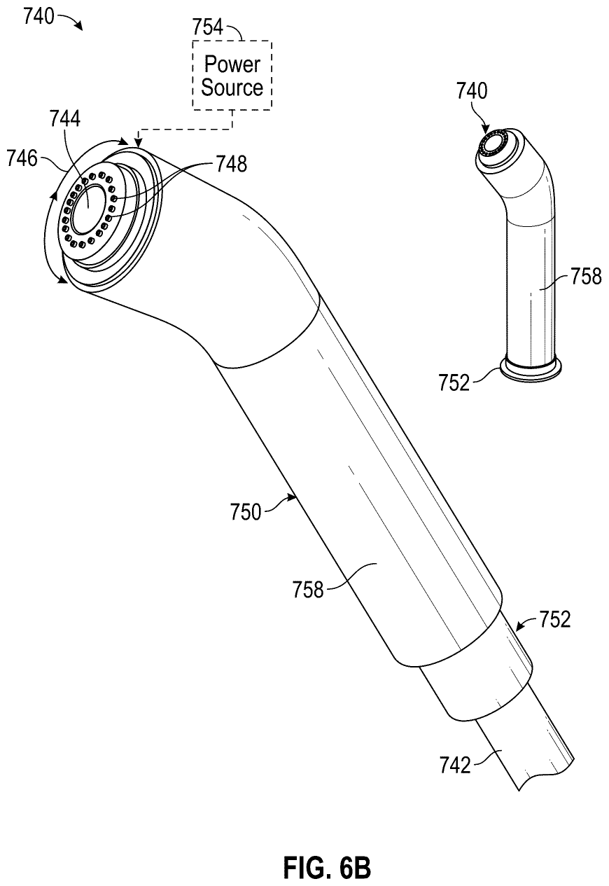

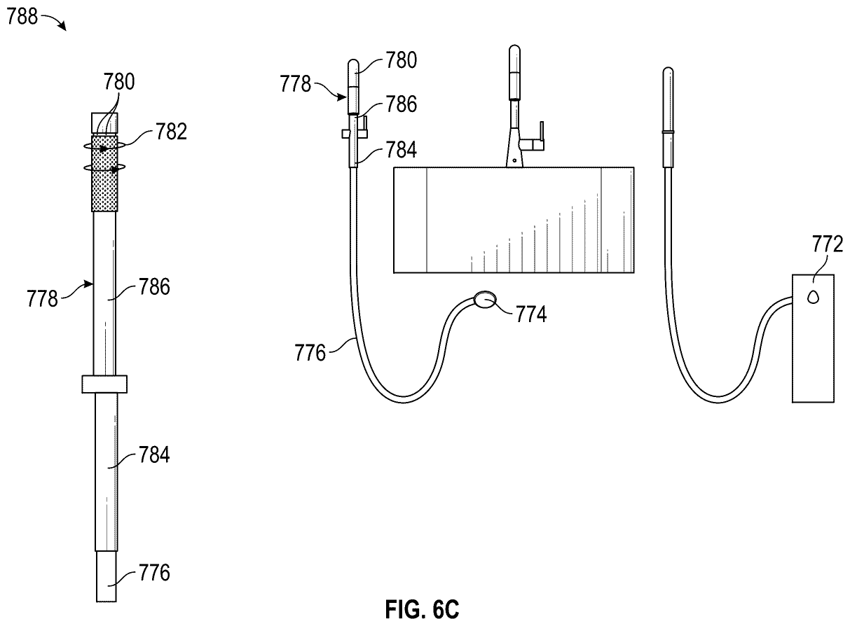

Up to this point, while a rotary sprayer has been discussed integrated with, or affixed to, a faucet assembly, in some examples, the rotary sprayer may be separate from, or independent of, the faucet assembly. For example, FIG. 6A is a perspective view of an add-on rotary sprayer according to one example of the present invention. Faucet assembly 700 includes a faucet 710 coupled to a spray head body 704 with an outlet 706 configured to receive a rotary sprayer 702. As shown, rotary sprayer 702 may be a separate and distinct component from faucet 710 and spray head body 704. To couple rotary sprayer 702 to spray head body 704, a coupling mechanism 708 may be used. In one example, coupling mechanism 708 includes a base 714 with a top 712 configured to interact with a receiving portion (not shown) within an outlet 706. In operation, a user may direct coupling mechanism 708 into outlet 706 and, once inserted, top 712 may automatically engage with the receiving portion to couple rotary sprayer 702 to spray head body 704. Once connected, rotary sprayer 702 can receive liquid from spray head body 704 and dispense the liquid out of nozzles 716. Rotational force may also be imparted to nozzles 716 through either water flow pressure or power source 718, which, in one example, includes a miniature internal or external motor connected to faucet assembly 700 through a link 720.

Once a cleaning cycle is completed, a user may provide a downward or rotational force to rotary sprayer 702 to disengage rotary sprayer 702 from spray head body 704. Rotary sprayer 702 may then be stored in the faucet 710 to return to a default operating condition. While one form of coupling mechanism 708 is shown, additional mechanisms are contemplated as well. For example, coupling mechanism 708 may include a threaded portion, latch, or other mechanical means for securing rotary sprayer 702 to spray head body 704. Furthermore, in other examples, each rotary sprayer 702 or coupling mechanism 708 may be manufactured or designed for specific faucet 710 SKUs.

In another example, a rotary sprayer may be included as part of a side sprayer with additional types of sprayers. For example, FIG. 6B is a perspective view of a side sprayer with a rotary sprayer in accordance with one example of the present invention. Side sprayer 740 is particularly useful for individuals who cannot or don't want to change their pre-existing faucet. Side sprayer 740 includes a nozzle 744 for aerated spray and rotary nozzles 748 for high-pressure, deep cleaning. In operation, rotary nozzles 748 can rotate in a circular motion 746 and dispense liquid in a high-pressure fashion. This rotary force may be supplied through water pressure or an internal or external power source 754.

Side sprayer also includes a handle 750 with a grip 758 selectively coupled to a hose 742. Grip 758 may be held by a user and consist of materials to allow for a strengthened grip. Handle 750 may be coupled to hose 742 through a coupling mechanism 752. Coupling mechanism 752 may include a threaded portion, snap feature, or any other mechanism for securing hose 742 to handle 750. In turn, hose 742 may be connected to a liquid source and provide liquid for side sprayer 740. Hose 742 may be made of a flexible material to allow a user to readily modify hose 742 while still allowing for passage of the liquid.

Additionally, in some examples, a rotary sprayer may operate independently from a faucet assembly or a side sprayer. For example, FIG. 6C is a perspective view of a standalone rotary sprayer in accordance with an example of the present invention. While rotary sprayers have been discussed with respect to faucets, in this example, rotary sprayer 770 is a standalone sprayer configured to operate independently from a faucet. Sprayer 770 includes a rotary sprayer 778 coupled to a handle 784, which, in turn, may be connected to a kitchen input 774 or an external reservoir 772 through a hose 776. In operation, liquid originates from kitchen input 774 or external reservoir 772 and traverses hose 776 to rotary sprayer 778. Once actuated, nozzles 780 of rotary sprayer 778 rotate in a circular fashion 782 and dispense the received liquid. Based on the positioning and rotation of nozzles 780, a defined spray pattern is observed as indicated generally by arrow 788. This spray pattern and corresponding positioning of nozzles 780 may be chosen to optimize the dispersion of liquid to clean an object of interest. Additionally, while kitchen input 774 and external reservoir 772 are implemented, it is contemplated that other internal water or liquid sources may be used as well in accordance with the present invention.

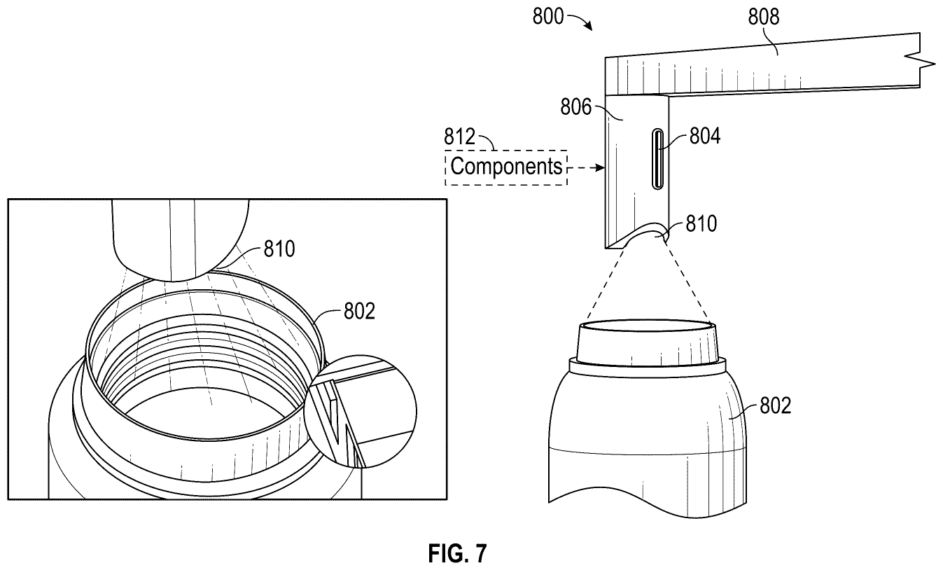

It is also contemplated that a faucet assembly may include additional functionality to assist a user in operating a rotary sprayer. For example, FIG. 7 is a perspective view of a faucet assembly with a rotary sprayer and light emitting device in accordance with an example of the present invention. Faucet assembly 800 includes a handle 808 coupled to a spray head body 806 that, in one example, includes both a rotary sprayer (not pictured) and a light emitting device 810. While light 810 is shown within spray head body 806, light 810 may be located within handle 808 or the rotary sprayer. In operation, light 810 may emit ultraviolet light, infrared light, or any other wavelength of light. Emitted light may be used to highlight a clarity of a vessel 802 before or after a cleaning cycle using a rotary sprayer. This may prove useful to show whether additional cleaning is necessary. Light 810 may be operated through components 812 located internal or external to faucet assembly 800. Components may include circuitry, power source, or any other components necessary for the function of light 810. Light 810 may be turned on through an actuation mechanism 804. Actuating mechanism 804 can include a button, switch, lever, etc. While illustratively shown on spray head body 806, actuating mechanism 804 may be located on other parts of faucet assembly 800 or, in some instances, external to faucet assembly 800.

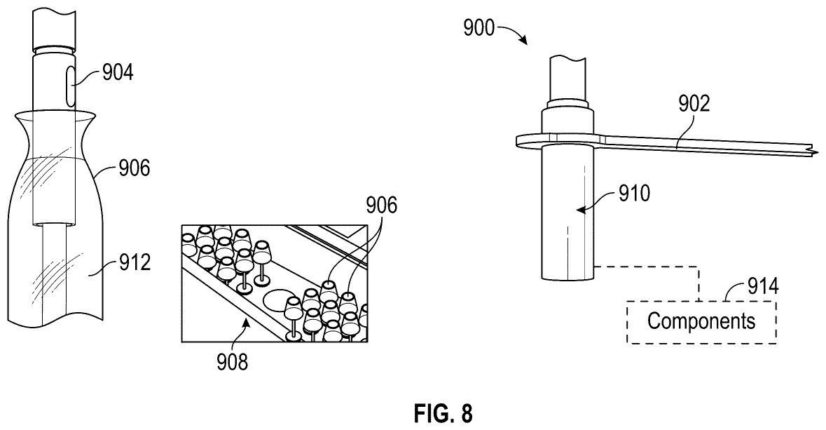

Additionally, a faucet assembly may include a rotary sprayer and ultrasound functionality to aid a user in a cleaning operation. For example, FIG. 8 is a perspective view of a faucet assembly with a rotary sprayer and ultrasound device in accordance with an example of the present invention. In this example, faucet assembly 900 includes a rotary sprayer 904 and an ultrasound device 910 capable of producing ultrasound. The production of ultrasound may prove useful in softening dirt within an object(s) 906, allowing for less detergent and scrubbing. Device 914 includes components 914 for producing ultrasound, which, in one example, includes circuitry, power source, and any other components necessary for the production of ultrasound.

In operation, a user can use rotary sprayer 904 to provide an initial cleaning and removal of dirt while filling object 906 with a liquid 912. Next, the user may activate device 910 through an actuation mechanism 904 to produce ultrasound within liquid 912. In turn, the ultrasound may release dirt and other residue within object 906. Rotary sprayer 904 may then be re-engaged to remove or further clean the released debris from object 906. To maintain a position of faucet assembly 900, a holder 902 may be used. Holder 902 may take various forms and be sized and shaped accordingly to grasp and maintain a position of rotary sprayer 904. In another example, faucet assembly 900 may clean multiple objects at once. Specifically, a sink 908 may be filled with liquid and device 910 activated to dislodge residue from all objects within sink 908 simultaneously. However, other examples are expressly contemplated herein.

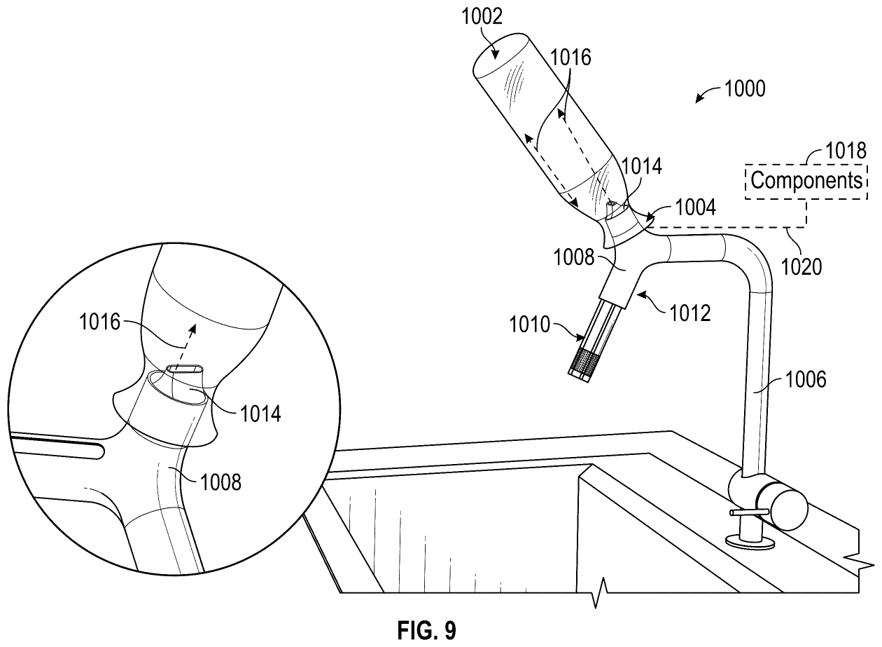

Once a rotary sprayer is utilized in a cleaning operation, a faucet assembly may also include a dryer to assist in drying a washed object. For example, FIG. 9 is a perspective view of a faucet assembly with a rotary sprayer and a dryer in accordance with an example of the present invention. Faucet assembly 1000 includes a faucet 1006 coupled to a rotary sprayer 1010 and a spray head body 1008 with a dryer 1004. Dryer 1004 may be used to dispel warm air into an object 1002. As illustrated, when object 1002 abuts dryer 1004, a funnel 1014 may orient an air flow stream 1016 into object 1002. In doing so, object 1002 may be dried in a hastened and efficient manner without leaving streaks or displacing bacteria on object 1002. Funnel 1014 may receive warm or heated air through a link 1020 coupled to components 1018. Components 1018 may include an internal or external heater, motor, and/or any other components necessary to produce heated air. Heated air may then be provided to dryer 1004 through link 1020, which may include any tubing or piping necessary to transmit the heated air.

To activate dryer 1004, an actuating mechanism 1012 may be used. Actuating mechanism 1012 may include a button, switch, lever, or any other mechanism suitable for engaging and activating dryer 1004. While dryer 1004 is illustratively coupled to a top portion of spray head body 1008, in other examples, dryer 1004 may be physically coupled to any portion of faucet assembly 1000. Additionally, it is expressly contemplated that funnel 1014 may take a wide variety of other shapes and forms depending on a desired pathway of warm air. In some instances, funnel 1014 may also be removeable and interchangeable with other types of funnels.

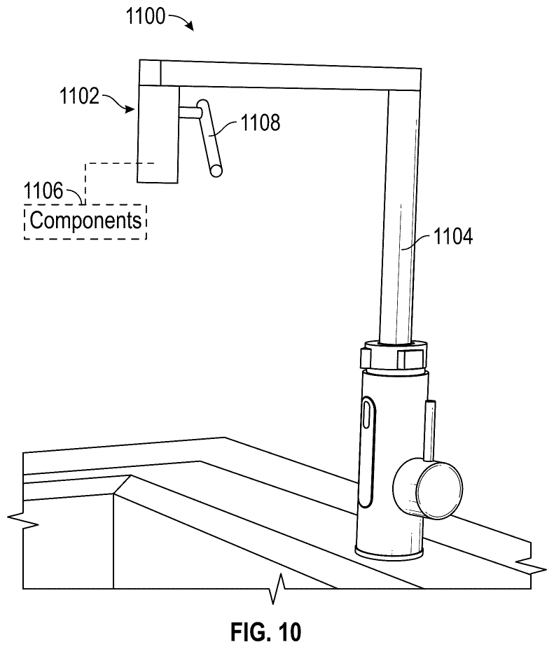

Lastly, a rotary sprayer, or a faucet assembly, may also include an ability to expel steam to assist a user in a cleaning operation. For example, FIG. 10 is a perspective view of a faucet assembly with a rotary sprayer and steam wand in accordance with an example of the present invention. Faucet assembly 1100 includes a faucet 1104 coupled to a spray head body 1102 with a rotary sprayer (not shown) and a steam wand 1108 for producing steam. While steam wand 1108 is shown external to spray head body 1102, in other examples, the rotary sprayer itself can dispel steam. In this example, the rotary sprayer may be able to produce steam and liquid for cleaning cycles. Steam may prove useful to soften stubborn dirt and achieve an elevated level of sterilization. Production of steam may be provided through components 1106. Components 1106, May include circuitry, a heater, motor, or any other components necessary to produce steam. Additionally, components 1106 may be located internal or external to faucet assembly 1100.

The aforementioned examples are not intended to limit the scope or bounds of the present invention. Additional examples may be included that combine the functionality or configurations of the discussed examples.

What is claimed is:

1. A faucet assembly with a spray head configured to receive and dispense a liquid, comprising:
a rotary sprayer coupled to the spray head comprising at least one nozzle on a spray body configured to rotate along an axis to dispense the liquid in a circular manner.

2. The faucet assembly of claim 1, wherein the at least one nozzle is a spray jet nozzle configured to dispense the liquid under high pressure.

3. The faucet assembly of claim 1, further comprising:
an actuating mechanism coupled to the faucet assembly that, when in a first position, maintains a position of the rotary sprayer within a housing of the spray head and, in a second position, displaces the rotary sprayer out of an outlet of the spray head.

4. The faucet assembly of claim 1, wherein the nozzle is driven by a rotary mechanism comprising either an electrical power source or water pressure to rotate along the axis to dispense the liquid in the circular manner.

5. The faucet assembly of claim 1, further comprising:
a cleaning module coupled to the spray body of the rotary sprayer comprising at least one opening configured to align with the at least one nozzle of the rotary sprayer so that, in operation, the liquid is dispensed from the at least one nozzle and through the opening of the cleaning module.

6. The faucet assembly of claim 1, further comprising:
an aerated nozzle coupled to an outlet of the spray head configured to receive the liquid and dispense an aerated stream of liquid; and
a specialized nozzle coupled to the outlet of the spray head configured to receive and dispense the liquid along an exterior of an object positioned adjacent to the specialized nozzle.

7. The faucet assembly of claim 6, wherein the specialized nozzle comprises either a full, sweep, or mist nozzle.

8. The faucet assembly of claim 1, wherein the rotary sprayer is further configured to expel microbubbles upon receiving a user input.

9. The faucet assembly of claim 1, further comprising:
a dispenser coupled to the spray head comprising a housing portion and an inlet configured to receive a cleaning solution, wherein the cleaning solution, upon being received within the inlet, is configured to contact the liquid within the spray head body.

10. The faucet assembly of claim 1, further comprising:
a lighting device coupled to the faucet assembly configured to emit a particular wavelength of light to illuminate residue on an object positioned adjacent to the lighting device.

11. The faucet assembly of claim 10, wherein the particular wavelength comprises a wavelength between 10 and 400 nm.

12. The faucet assembly of claim 1, further comprising:
an ultrasound device coupled to the faucet assembly configured to emit ultrasound upon receiving a user input through an actuating mechanism of the faucet assembly.

13. The faucet assembly of claim 1, further comprising:
a dryer coupled to the spray head of the faucet assembly configured to dispel warm air through a funnel and into an interior of an object positioned adjacent to the dryer.

14. The faucet assembly of claim 1, wherein the rotary sprayer is further configured to deliver steam upon receiving a user input through an actuating mechanism of the faucet assembly.

15. A faucet assembly configured to receive and dispense a liquid from a liquid source, comprising:
a spray head comprising a first nozzle coupled to an external surface of the spray head configured to dispense the liquid while in a first operating mode, and a second nozzle coupled to an outlet of the spray head configured to dispense the liquid through the outlet while in a second operating mode; and
a diverter configured to switch between the first and the second operating modes upon receiving a user input.

16. The faucet assembly of claim 15, wherein the first nozzle comprises a plurality of nozzles configured to dispense the liquid in a cross-jet pattern while in the first operating mode, and wherein the second nozzle comprises an aerated nozzle configured to receive the liquid and dispense an aerated stream while in the second operating mode.

17. The faucet assembly of claim 16, further comprising:
a cleaning module physically coupled to the external surface of the spray head.

18. The faucet assembly of claim 15, wherein the first nozzle rotates along a central axis and comprises a plurality of nozzles encapsulating a lower external surface of the spray body, and wherein the diverter comprises a sleeve that, in the first operating mode, is removably displaced from the first nozzle and, in the second operating mode, is removably coupled to the first nozzle.

19. A rotary sprayer configured to dispense a liquid, comprising:
a rotary body configured to receive the liquid from a liquid source;
a spraying portion fixedly coupled to the rotary body to receive the liquid, the spraying portion comprising a plurality of nozzles that, in operation, are configured to rotate along a central axis through a rotary mechanism to dispense the liquid in a circular manner, the rotary mechanism comprising an electrical or water pressure source.

20. The rotary sprayer of claim 19, further comprising:
a tip configured to receive a cleaning module, the cleaning module comprising a plurality of openings configured to align with the plurality of nozzles.
